(19) United States
(12) Patent Application Publication
(10) Pub. No.: US 2025/0130339 A1
(43) Pub. Date: Apr. 24, 2025

(54) RENEWABLE BIO-POLYMER BASED SOLID-STATE GAMMA RADIATION DETECTOR-DOSIMETER

(71) Applicant: PURDUE RESEARCH FOUNDATION, West Lafayette, IN (US)

(72) Inventor: Rusi P. Taleyarkhan, West Lafayette, IN (US)

(21) Appl. No.: 18/917,230

(22) Filed: Oct. 16, 2024

Related U.S. Application Data
(60) Provisional application No. 63/544,881, filed on Oct. 19, 2023.

(51) Int. Cl. G01T 1/167; G01T 7/02

(52) U.S. Cl. CPC G01T 1/167; G01T 7/02

(57) ABSTRACT

Systems and methods of measuring a radiation dose implement and/or comprise preheating a hot press, wherein the hot press includes a first platen and a second platen; loading the hot press with a sample assembly, wherein the sample assembly includes a first release liner, a second release liner, a mold disposed between the first release liner and the second release liner, and a sample disposed between the first release liner and the second release liner and adjacent to the mold, wherein the sample has been exposed to the radiation dose and includes a polylactic acid (PLA) resin; compressing the sample assembly with the hot press; measuring a physical parameter of the sample; and determining the radiation dose based on the measurement of the physical parameter.

### CROSS-REFERENCE TO RELATED APPLICATIONS

This application claims priority to and the benefit of the U.S. Provisional Patent Application No. 63/544,881, filed Oct. 19, 2023 and titled “Solid-State Gamma Radiation detector-dosimeter systems and methods,” the entire contents of which are herein incorporated by reference for all purposes.

### STATEMENT REGARDING FEDERALLY SPONSORED RESEARCH OR DEVELOPMENT

This invention was made with government support under 89303321CEM000080 awarded by the Department of Energy. The government has certain rights in the invention.

### TECHNICAL FIELD

The present disclosure is directed to a system and method to determine the gamma irradiation (GI) dose through correlation of changes in the rheological properties of polylactic acid (PLA). More particularly, the present disclosure is directed to a dosimeter composed of PLA beads.

### BACKGROUND

Polylactic acid (PLA) as a “green,” renewable corn-soy based polymer resin was assessed as a solid-state detector for rapid-turnaround gamma radiation dosimetry in the 1-100 kGy range—of significant interest in biomedical and general nuclear industry applications. Co-60 was used as the source of gamma photons. PLA resin responds well in terms of rheology and porosity metrics with an absorbed gamma dose (Dg). Rheological changes were ascertained via measuring the differential mass loss ratio (MLR) of irradiated PLA placed within PTFE framed (40 mm×20 mm×0.77 mm) cavities bearing ˜0.9 g of PLA resin and pressed for 12-16 min in a controlled force hot press under ˜6.6 kN loading and platens heated to 227° C. for the low Dg range: 0-11 kGy; and to 193° C. for the extended Dg range: 11-120 kGy. MLR varied quadratically from 0.05 to ˜0.2 (1σ˜0.007) in the 0-11 kGy experiments, and from 0.05 to ˜0.5 (1σ˜0.01) in the 0-120 kGy experiments. Rheological changes from gamma irradiation were modeled and simultaneously correlated with void-pocket formations, which increase with Dg. A single PLA resin bead (˜0.04 g) was compressed 5 min at 216° C. in 0-16 kGy experiments, and compressed 2 min at 232° C. in the 16-110 kGy experiments, to form sturdy ˜100 μm thick wafers in the same press. Aggregate coupon porosity was then readily measurable with conventional optical microscope imaging and analyzed with standard image processing; this provided complementary data to MLR. Average porosity vs. dose varied quadratically from ˜0 to ˜15% in the 0-16 kGy range and from ˜0 to ˜18% over the 16-114 kGy range. These results provide evidence for utilizing “green”/renewable (under $0.01/bead) PLA resin beads for rapid and accurate (+/−5-10%) gamma dosimetry over a wide 0-120 kGy range, using simple to deploy mass and void measuring techniques using common laboratory equipment.

Nominal gamma irradiation detectors can cost anywhere from millions of dollars (for radiation spectrometers) to 1-10 thousand dollars (for portable survey equipment), to $10 per detector for personal dosimeters (such as thermoluminescence dosimeters (TLDs)). There is a need for a dosimeter that provides for a decrease in material cost.

### SUMMARY

The present disclosure addresses these and other shortcomings of the comparative art by presenting, in an example, systems and methods for radiation dosimetry (e.g., gamma or other dosimetry) utilizing a polylactic acid resin and a hot press, in which the dose may be determined from changes in physical parameters of the resin.

According to one aspect of the present disclosure, a system of measuring a radiation dose is provided. The system comprises a first platen; a second platen disposed opposite the first platen; and a sample assembly disposed between the first platen and the second platen, the sample assembly comprising a first release liner, a second release liner, a mold disposed between the first release liner and the second release liner, and a sample disposed between the first release liner and the second release liner and adjacent to the mold, wherein the sample has been exposed to the radiation dose and includes a polylactic acid (PLA) resin, wherein the first platen and the second platen are configured to compress the sample assembly in a heated state.

According to another aspect of the present disclosure, a method of measuring a radiation dose is provided. The method comprises preheating a hot press, wherein the hot press includes a first platen and a second platen; loading the hot press with a sample assembly, wherein the sample assembly includes a first release liner, a second release liner, a mold disposed between the first release liner and the second release liner, and a sample disposed between the first release liner and the second release liner and adjacent to the mold, wherein the sample has been exposed to the radiation dose and includes a polylactic acid (PLA) resin; compressing the sample assembly with the hot press; measuring a physical parameter of the sample; and determining the radiation dose based on the measurement of the physical parameter

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates example PLA resin beads according to various aspects of the present disclosure.

FIG. 2 illustrates relative gamma dose map for an irradiator according to various aspects of the present disclosure.

FIG. 3 illustrates example dose variation results according to various aspects of the present disclosure.

FIG. 4 illustrates example frames according to various aspects of the present disclosure.

FIG. 5 illustrates an example apparatus according to various aspects of the present disclosure.

FIG. 6 illustrates damaged a PTFE mold according to various aspects of the present disclosure.

FIG. 7 illustrates DSC results according to various aspects of the present disclosure.

FIG. 8 illustrates samples according to various aspects of the present disclosure.

FIG. 9 illustrates MLR according to various aspects of the present disclosure.

FIG. 10 illustrates sample fragility according to various aspects of the present disclosure.

FIG. 11 illustrates MLR according to various aspects of the present disclosure.

FIG. 12 illustrates MLR according to various aspects of the present disclosure.

FIG. 13 illustrates a flow chart showing the protocol for MLR determination according to various aspects of the present disclosure.

FIG. 14 illustrates MLR experimentation samples according to various aspects of the present disclosure.

FIG. 15 illustrates one resin bead according to various aspects of the present disclosure.

FIG. 16 illustrates PLA resin beads according to various aspects of the present disclosure.

FIG. 17 illustrates a porosity measurement device according to various aspects of the present disclosure.

FIG. 18 illustrates thickness of the samples for porosity measurements according to various aspects of the present disclosure.

FIG. 19 illustrates a wafer sample according to various aspects of the present disclosure.

FIG. 20 illustrates microscopic images according to various aspects of the present disclosure.

FIG. 21 illustrates microscopic images according to various aspects of the present disclosure.

FIG. 22 illustrates an example of a processed image according to various aspects of the present disclosure.

FIG. 23 illustrates a flow-chart summary of a porosity testing method according to various aspects of the present disclosure.

FIG. 24 illustrates MLR of the PLA resin according to various aspects of the present disclosure.

FIG. 25 illustrates MLR of the PLA resins according to various aspects of the present disclosure.

FIG. 26. illustrates porosity according to various aspects of the present disclosure.

FIG. 27 illustrates porosity according to various aspects of the present disclosure.

FIG. 28 illustrates an example dose analysis device according to various aspects of the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various aspects of the present disclosure. However, it will be apparent to those skilled in the art that the various features, concepts, and aspects described herein may be implemented and practiced without these specific details.

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

The present disclosure includes a description of various methods. For any methods described, regardless of whether the method is described in conjunction with a flow diagram, it should be understood that unless otherwise specified or required by context, any explicit or implicit ordering of steps performed in the execution of a method does not necessarily imply that those steps must be performed in the order presented, but instead the steps may be performed in a different order and/or in parallel.

The following discussion is presented to enable a person skilled in the art to make and use aspects of the invention. Various modifications to the illustrated aspects will be readily apparent to those skilled in the art, and the generic principles herein can be applied to other aspects and applications without departing from aspects of the invention. Thus, aspects of the invention are not intended to be limited to aspects shown but are to be accorded the widest scope consistent with the principles and features disclosed herein. The following detailed description is to be read with reference to the figures, in which like elements in different figures have like reference numerals. The figures, which are not necessarily to scale, depict selected aspects and are not intended to limit the scope of aspects of the invention. Skilled artisans will recognize the examples provided herein have many useful alternatives and fall within the scope of aspects of the invention.

Gamma radiation is omnipresent in daily life. From safety and utility considerations, gamma dosimetry is utilized worldwide in a wide range of industries and disciplines. For the past over 80 years, ionizing radiation monitoring technology has remained largely the same-relying primarily on sensor technologies that require monitoring for the telltale charge buildup in ionized gases/solids (e.g., fission chambers using highly enriched uranium and compensated ion chambers) or monitoring of light flashes from scintillation or thermoluminescence. Complex and bulky radiation spectrometers can cost in the millions (as may be deployed at high powered accelerator-driven spallation sources or research reactor facilities and require skilled scientific staff), down to a range of $1000-$10,000 for portable survey meters, and even at as low as $10/detector for commonly used personnel dosimeters (e.g., TLDs). The need for gamma dose measurements can span a large dose range. At the low level, the dose rate can be as low as ˜10⁻⁸ Gy/h (1 μRad/h) for cosmic background levels. In the intermediate range of ˜1-10 kGy, it could apply, for example, to food irradiation and packaging sterilization. At the higher levels, to 100 kGy and higher, it is applied in diverse fields, such as in medicine, high power nuclear reactors, and accelerator driven systems where the exposure dose rates may exceed 10⁴ kGy/h (10⁹ R/h).

As is evident, it would be a desirable outcome if one could develop and demonstrate a potentially transformational advance in radiation and associated dose monitoring technology, resulting in a novel, nonpowered solid state, ultra-lightweight-scalable [e.g., ˜1 g (˜2 mm size) detector], affordable (e.g., <$0.10/unit), corn-soy polylactic acid (PLA) biodegradable, environmentally friendly, easy-to-use, general purpose gamma-beta-alpha-fission neutron monitor that is readily deployable (especially in extreme, e.g., 1000-100,000 R/h) radiation fields for use in ensuring facility safety and operations across the DOE nuclear infrastructure, and for enabling deployment over a wide range of ambient temperatures.

In comparative examples, scoping efforts to develop a PLA-based solid-state radiation detector (PLAD) based on monitoring irradiated PLA specimens for morphological changes using FTIR- and relative viscosity (RV)-based techniques were tested. Advancements have been made in PLAD technology that permits gamma detection-dosimetry using significantly simplified techniques based on the underlying physics of PLA rheological changes that correlate with gamma radiation.

Proposing PLAD, which is based on monitoring for tell-tale damage caused by ionizing radiation in materials is done for a number of reasons. Ionizing radiation interaction will produce atom dislocations, electron transitions and other effects in virtually all materials. For example, neutron irradiation of steel walls can result in embrittlement. However, such dislocations and property changes (e.g., melting temperature, color or viscosity) are not readily discernible for monitoring in real time using commonly available devices and techniques. What is needed is a material that responds reasonably well, even in harsh nuclear environments, to varied forms of ionizing radiation to produce well correlated property changes to simple physical properties (e.g., density, relative viscosity, hardness, Hf, molecular weight, color changes) that are amenable to rapid-fire and cost-effective measurement using common laboratory equipment. Specifically, results are presented pertaining to gamma radiation dosimetry enablement based on PLA polymer resins for application in the 1-100 kGy dose range. That is, to develop a PLA based dosimeter, we will refer to it as PLAD to offer a potentially viable and novel breakthrough alternative to present-day gamma radiation monitors.

PLA is a “green,” corn-soy based biopolymer and has been widely used in medical applications such as implants, surgical sutures, drug formulations and deliveries, food packaging industries, and also as an adhesive. Its NFPA (National Fire Protection Association) rating is “0 1 0” for safety, flammability and reactivity.

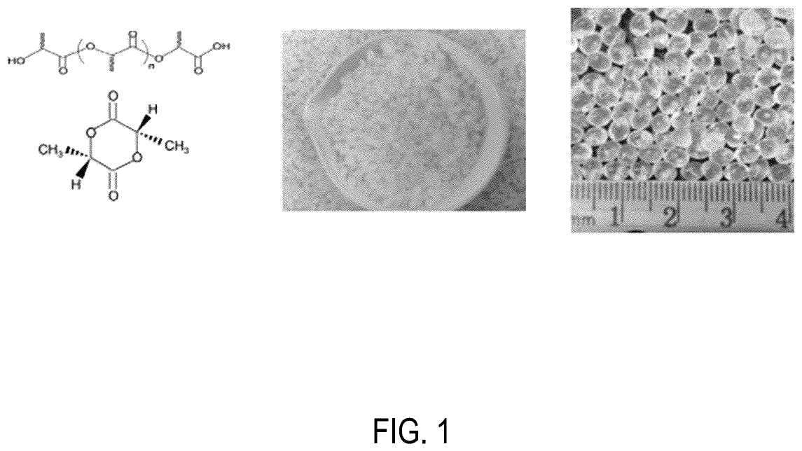

Referring now to FIG. 1 which provides salient information on the molecular formula and physical characteristics of PLA resin beads. In particular, FIG. 1 illustrates, at left, the PLA molecular structure; at center, ˜3 mm resin beads in a cup; and at right, a closeup with scale. The example PLA resin was supplied by Natureworks, LLC.

Scoping studies (in-house at Purdue University and elsewhere) have revealed that gamma irradiation of PLA can significantly alter morphology and physical properties. The morphological changes alter both the polymer in terms of MW and the associated strength when subject to ionizing radiation with and without crosslinking. It was hypothesized that the mechanical effects should also alter the rheological flow properties of the PLA resin itself, such that it would flow and exhibit macroscopic microstructural (void/pore formation) variations in direct correlation to the absorbed dose-both features acting as metrics for absorbed gamma dose and hence result in PLAD as a rapid-readout gamma dosimeter.

The application of PLA in medical instruments potentially opens up its possibility for internal dosimetry, yet the dose levels for radiotherapy achieved in comparative examples are generally no more than 100 Gy. However, potentials still lie in the dosimetry in X-ray facilities, where the dose rate could reach 480 Gy/h, and in food packaging and sterilization industries, where the dose applied could reach 10 kGy and above for chem-bio agent defeat. Significantly higher levels of gamma dose must be considered when deciding on the choice of polymer materials for radiation-sterilized products—for the most part through 100 kGy and even toward 4000 kGy depending on the specific polymer chosen.

Consequently, in support of the present disclosure, PLAD was evaluated for functionality as a low-cost and near real-time dosimeter for dose monitoring in the 1-100 kGy dose range; such dose ranges could be conveniently accommodated via access to irradiator devices that are relatively widely accessible.

One objective then was to derive, research and demonstrate methods for measuring rheological and voiding metrics using techniques that are simple and that use widely available equipment.

Experiments and protocols were developed to study two physical effects of gamma dose (Dg) effects on PLA resin on: (1) Changes in heated resin deformation and mass loss when subject to mechanical compression, and (2) Monitoring the average void fraction (i.e., porosity) in irradiated PLA resin.

Due to its ready availability and experience in use as an adhesive, Nature Works® Ingeo™ biopolymer resin 4043D was used in this analysis, which is a semi-crystalline polymer. Some typical properties are listed in Table 1.

Referring back to FIG. 1 which provides a view of the colorless transparent resin beads supplied by Nature Works, LLC.

TABLE 1
Physical properties for Ingeo ™ Biopolymer 4043D

| Parameter | Value |
|---|---|
| Specific Gravity, g/cc | 1.24 |
| Relative Viscosity | 4.0 |
| Melt Temperature, ° C. | 145-160 |
| Glass Transition Temperature, ° C. | 55-60 |
| Decomposition temperature, ° C. | 250 |
| Mass Flow Rate, g/10 min, for 210° C./2.16 | 6 |
| kg conditions | |

Purdue University's Nordion GammaCell 220™ Co-60 irradiator was used to perform y photon irradiation of the PLA resin samples. The average dose in the unit was initially calibrated with Fricke dosimetry in 1993 and the dose rates extending to the time of usage were evaluated based on the decay of the Co-60 source. The accuracy of the estimated dose rate is ±0.56% at the 95% confidence limits. By the time irradiation was performed, the dose rates were, in general, on the order of 2 kGy/day.

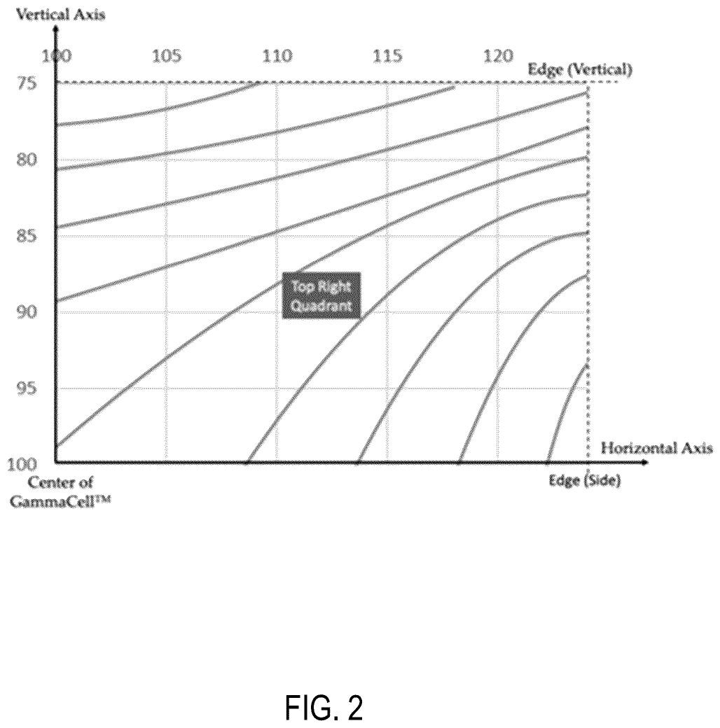

Referring now to FIG. 2 which shows the dose map provided by the manufacturer.

The dose evaluated by Fricke dosimetry was converted to the actual dose absorbed by PLA. Nevertheless, the converted dose has little difference to which Fricke dosimetry evaluates, since the Mass Absorption Coefficient (provided by the National Institute of Standards and Technology database) of ferrous sulfate, the main component of standard Fricke dosimetry, is very close to that of PLA exposed to 1.25 MeV photons, the average energy of 1.17 and 1.33 MeV for Co-60 photons (0.02955 cm²/g for ferrous sulfate and 0.02816 cm²/g for PLA).

A MCNP code simulation was also built characterizing the irradiator core for its spatial radiation dose rate profile, results of which were used to guide for the positioning of samples used for this current study.

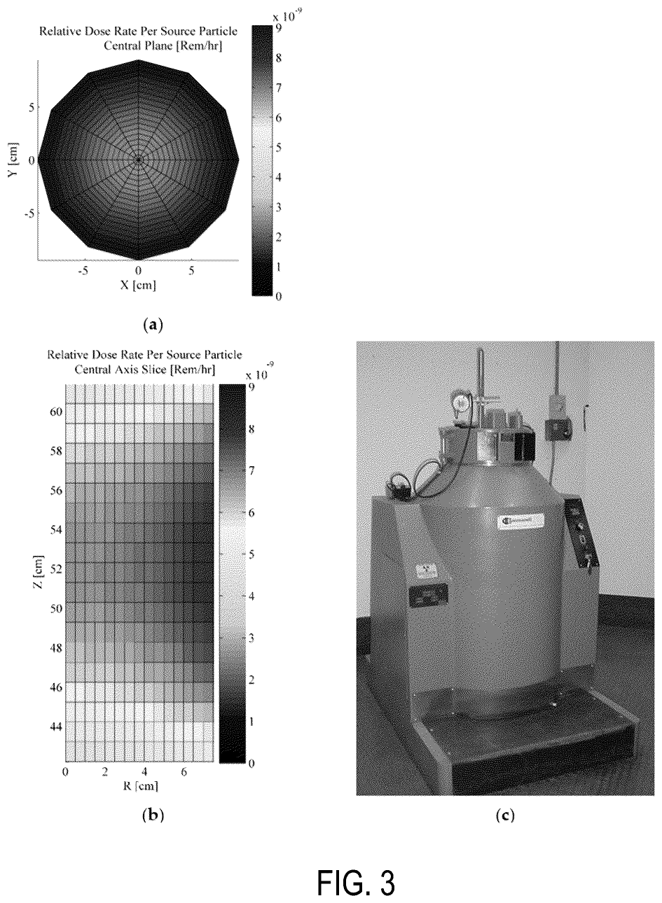

FIG. 3 provides the results of dose variation with radial (from the centerline) and axial locations within the irradiator, and thus shows the MCNP code model results of dose rate variations in the irradiator. In FIG. 3, graph (a) shows the mid-section, axial results; graph (b) shows the R-Z slice, radial results; and image (c) shows the irradiator itself. PLA resins were irradiated in the presence of room air. The maximum dose received was 114.4 kGy.

From both evaluations, it was found that the dose rate at the wall was about 20% higher than at the center. During irradiation, the samples were kept at the center area of the chamber, and the bottles containing the resins were shaken from time to time to unify.

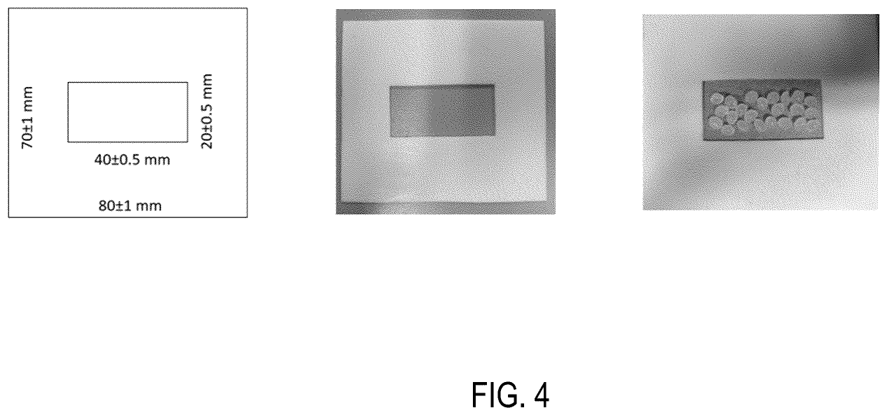

In order to evaluate and quantify the rheological changes with gamma irradiation dose, it was decided to configure a system for operations, as shown schematically in FIG. 4.

FIG. 4 shows a schematic and pictorials of PTFE frames with and without PLA resin PTFE (Polytetrafluoroethylene) sheets provided by McMaster Carr™, melting range 327-342° C., relative density 2.14-2.19 g/cm³ at 20° C.; the thickness of the sheet is 0.77=0.01 mm.

The system comprises a cavity within a thin polytetrafluoroethylene (PTFE) enclosure frame into which a mass (mₒ) of PLA resin material (with or without irradiation) is placed evenly within the cavity space-both of which are shown in FIG. 4. The area dimension of the cavity was chosen from practical considerations to align with that of a single flattened PLA resin bead (commonly sold as feedstock worldwide by NatureWorks, LLC.)—such that, upon compression, a measurable quantity of the molten PLA material can egress out of the cavity. PTFE was chosen as the frame material for this example due to its non-wetting property and ability to withstand adhesion to molten PLA, thereby permitting the controlled flow of PLA under pressure and heat. In other implementations, however, the frame may be formed of any low-surface-energy (LSE) material; that is, any material that exhibits little adhesion to PLA (e.g., has a surface energy below 36 dyne/cm). For example, the frame may be formed of polyvinyl fluoride (PVF), polypropylene (PP), polyethylene (PE), ethylene-vinyl acetate (EVA), polystyrene (PS), and the like. This coupon is then compressed in a hot press, during which the molten PLA is allowed to flow out of the cavity (i.e., create a mass release “m”) to differing levels, depending on irradiation-based changes in overall relative viscosity. An extra technical issue needed attention. Under hot press compression, molten PLA adhesion to upper-lower steel surfaces must be avoided. To achieve this requirement, during the hot-press compression stage, a thin sacrificial release liner was positioned between the frame and the steel sheets on either side. Through trial-error, a commonly used food industry packaging material sold in grocery stores-parchment paper from Big Chef® was found to be suitable. The parchment paper specifications are: thickness: 0.045±0.005 mm, maximum temperature for safe usage: 218° C.; non-wettable to PLA melt and water—in laboratory tests the parchment paper exhibited 106.5±6.7 degrees contact angle with 0.5 μL deionized-filtered water drop.

The resultant mass loss ratio (MLR) metric is then derived as

$$MLR = {m}_{r} / {m}_{o} . \qquad ( 1 )$$

where, mᵣ is the PLA mass amount that is released from the cavity region, and mₒ is the original PLA mass within the cavity, respectively.

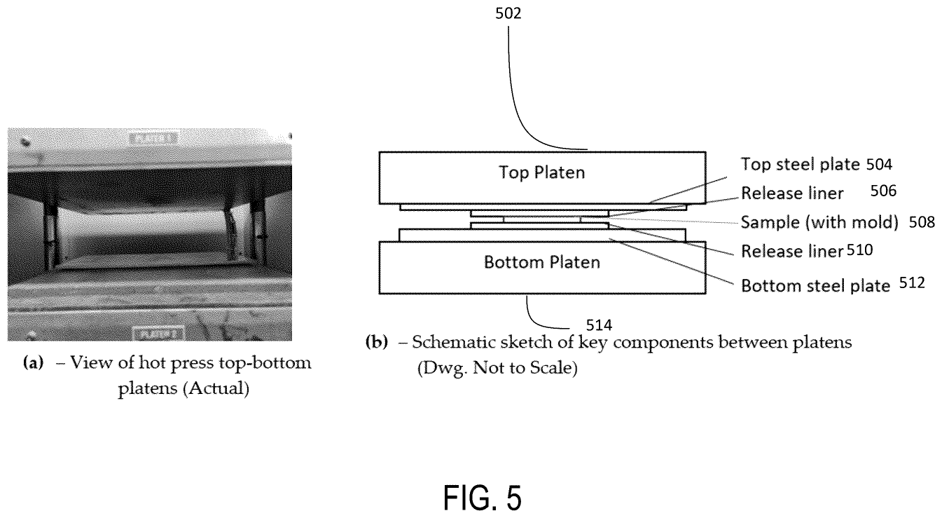

A high-fidelity apparatus [Carver Model AutoFour/30-1H™ manufactured by Wabash MPI, located in Wabash, IN, USA] was deployed for this analysis, as shown in FIG. 5. In particular, image (a) of FIG. 5 shows a view of hot press top-bottom platens, and image (b) of FIG. 5 shows a schematic sketch of various components between the platens. Image (b) is not to scale. This hot press enables controlled, radially uniform compression under temperature—to provide up to 294,000 N clamping force using 4 vertical columns with two 0.38 m×0.38 m electrically heated steel-platens. The pre-programmed platen temperatures were varied from ˜177° C. (350° F.) up to 232° C. (450° F.) in this analysis. This press permitted programmable application of desired loads, duration of compression and pre-determined hot platen surface temperatures (with minimal radial temperature variation-which were also verified and characterized). A K-type thermocouple positioned at various distances from the centerline was used to map out the temperature profile. It was found that measured temperature varies from the set temperature with increased distance from the centerline-varying from a low of ˜0.33° C. (˜0.4%) to ˜1.67° C. (˜1.5%) at the centerline to about 1.17° C. (˜1.5%) to 3.3° C. (˜3%) at the edges. However, for the present analysis, the PLA bearing sample is only 0.04 m×0.02 m, and is deliberately positioned at the center of the press; the temperature variations are expected to be <0.1° C. over the dimension of the coupon samples.

As mentioned earlier, the analyses conducted herein have shown that PLA can serve as a hot-melt adhesive for joining a vast array of materials, including steel, thereby potentially contaminating the platen surfaces in the case of leakage past the release liner 506. As an added precaution, a 0.3 m×0.3 m×0.013 m (12″×12″×0.5″) steel plate 512 was placed between the bottom platen 514 and the sample 508, while a 0.15 m×0.3 m×0.005 m (6″×12″×0.2″) steel plate 504 was placed between the top platen 502 and the sample 508, as shown in image (b) of FIG. 5. A release liner 506 is between the top steel plate 504 and the sample (with mold) 508. A second release liner 510 is below the sample 508. A bottom steel plate 512 is positioned between the sample 508 and the bottom platen 514.

Referring now to image (a) of FIG. 5 which shows a photograph of the view of a hot press top-bottom platens.

Referring now to image (b) of FIG. 5, a schematic sketch of key components between platens is shown. The top platen 502 is above the top steel plate 504 which is placed between the top platen 502 and the sample (with mold) 508. The sample (with mold) 508 is between a first release liner 506 and a second release liner 510. The first and second release liners 506 and 510 are to prevent leakage of the PLA resin. The top steel plate 504 and a bottom steel plate 512 are used as reinforcement to prevent the PLA resin from contaminating the top platen 502 and the bottom platen 514 respectively. The second release liner 510 is connected to the bottom steel plate 512. The bottom steel plate 512 is connected to the bottom platen 514.

As mentioned earlier, the cavity size was chosen to accommodate ˜1 g of PLA resin. To target MLR studies, the issue of the PTFE (0.77 mm thick, 20 mm×40 mm) mold expansion under heating conditions also needed to be taken into account. Based on the coefficient of thermal expansion of PTFE provided in the datasheet, the volumetric expansion of the Teflon® PTFE mold is ˜4% when heated from room temperature to 193° C. and ˜5% when heated to 227° C. Since 0.8 g of PLA is enough to fill an expanded PTFE mold when heated to 193-227° C., an excess 0.1 g was deemed appropriate for deriving significant MLR values; therefore, 0.9 g was eventually chosen as the mass amount of PLA.

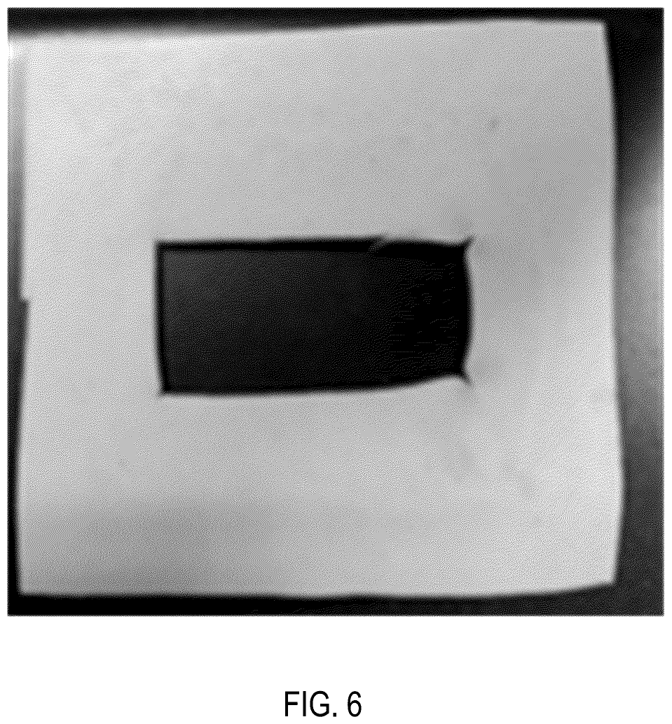

The minimum stated force that the Carver™ Press can apply is 4448 N (1000 lbF). While the load for MLR studies is preferred to be kept as low as possible for the purpose of allowing significant amounts of PLA to escape, it was also found that the press could not maintain stable loading significantly below 6672 N (1500 lbF). Higher forces could also be applied, but if too high a force is applied (e.g., 44,480 N), permanent distortion occurs to the PTFE mold itself, as seen in FIG. 6. In particular, FIG. 6 shows damage for a mold compressed under 44,480 N at 227° C. Consequently, the chosen baseline compression force was set at 6672 N (1500 lbF).

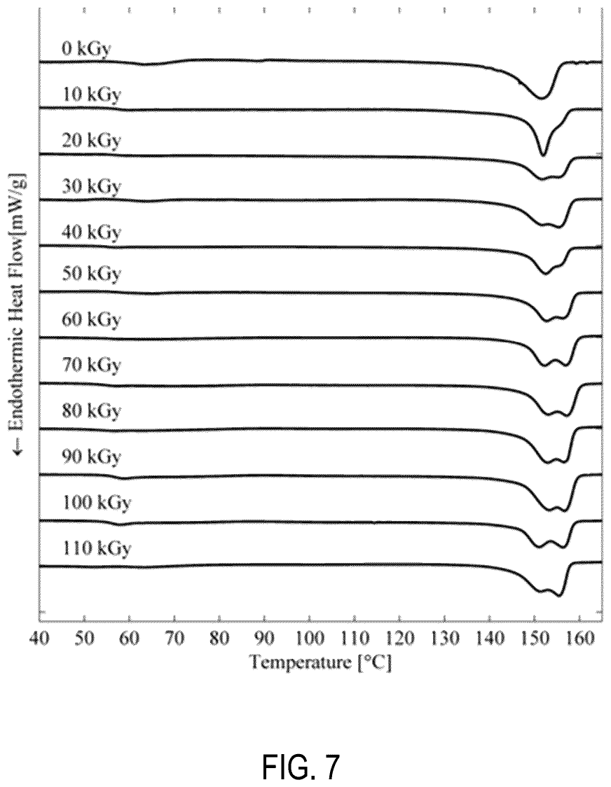

The hot press temperature and the associated time duration for compression under temperature may be selected based on results of differential scanning calorimetry (DSC). The DSC curves of PLA 4043D resins irradiated with various gamma doses (from 10 to 110 kGy) are shown in FIG. 7. The curves show that the melting of 4043D resins of various gamma doses starts from ˜140° C. and continues until ˜160° C. This result agrees with the nominal melting temperature of 4043D (145-160° C.) claimed by NatureWorks®. Another technicality relates to significant PLA decomposition onset at 250° C. as noted from Table 1.

Based on the above, the MLR studies were conducted with platen temperatures above 140° C., which allow significant material flow, but should not exceed 250° C. It was also found that the same press temperature and hold time under compression would not be appropriate over the entire 0 to 120 kGy range—i.e., to obtain good resolution at low as well as at high irradiation dose levels. This required finding a suitable combination of MLR-related test parameters for the high (11-120 kGy) range and low (0 to 11 kGy) range, separately. This is discussed below in sequence.

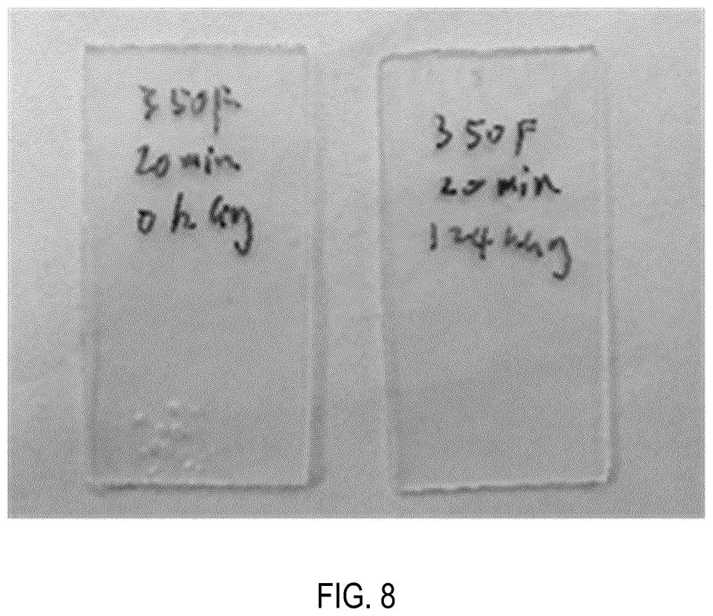

During trials, exploration started from 177° C. (350° F.) and an arbitrary (but reasonably long) compression time of 20 min. However, this resulted in only ˜12% mass loss for 124 kGy after 20 min of compression (Table 2), which was not deemed to be sufficiently large for allowing good resolution dosimetry from 0 to 100 kGy range. FIG. 8 shows the post-compressed PLA sample coupons (i.e., the PLA sample mass remaining within the PTFE mold's cavity). In FIG. 8, the sample on the left corresponds to 0 kGy and the sample on the right corresponds to 124 kGy (2014/2015). Both samples correspond to resins tested at 177° C. for 20 min.

TABLE 2
Mass loss ratio (MLR) for 124 kGy
resin tested at 177° C. for 20 min.

| Dose (kGy) | MLR |
|---|---|
| 0 | 0.0225 |
| 124 | 0.1250 |

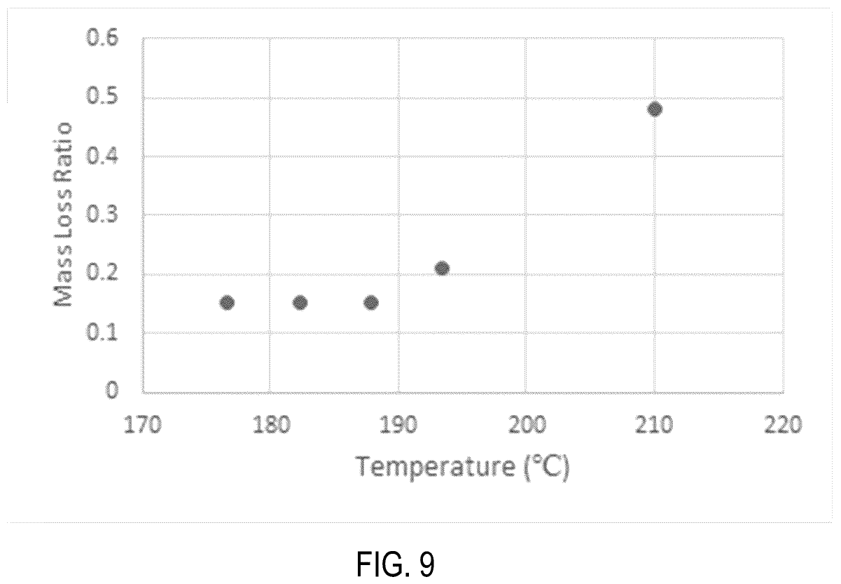

To save time and increase the resolution of dose predictions from 0 to 100 kGy, in lieu of longer compression time, it was first decided instead to assess the effect of temperature on the rheology. FIG. 9 shows the results of MLR for 124 kGy irradiated PLA resin, held at various temperatures from 177° C. to 210° C.—all compressed under 6672 N force for 10 min duration. The upper end of the temperature scale was chosen to remain compatible with the mass flow rate metric specified by the manufacturer (Table 1)—meant to be the industrial temperature for extrusion.

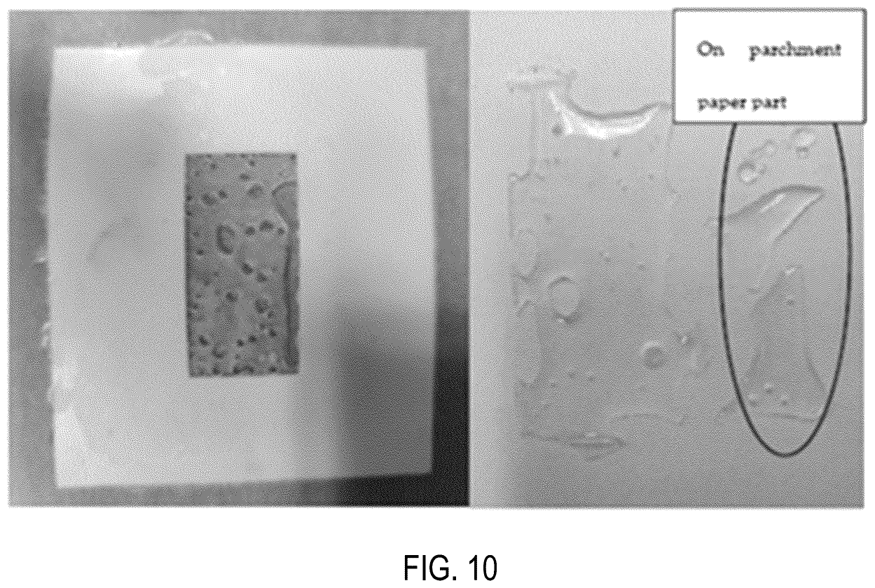

As seen in FIG. 9, the MLR rises rapidly above 190° C. to reach a substantial value of ˜0.5 at 210° C. However, this high level also gave rise to practical issues. Post-compression, the PLA sample became fragile enough so as to make it difficult to handle without shattering and breakage. Furthermore, the PLA resin also starts to attack and adhere to the release liner (see FIG. 10), which compromises the accuracy of MLR measurements with high levels of uncertainty. In FIG. 10, the fragile sample remaining in the mold cavity with holes is shown at left, and adhesion to the release liner is shown at right.

In order to avoid the issues discussed above, 193° C. (380° F.) was eventually chosen as the compromise temperature.

Next, the hold time duration at the temperature was determined. Attempts were then made to find the optimal hold time by determining the MLR for various hold times.

The inflexion time point was deemed to occur at/around 12 min, at which point the MLR was sufficiently high and sample examinations could be conducted without disintegration or adhesion to the release liner. As a side note, at the end of 12 min of compression, an additional 1 min rest time was allowed after releasing the pressure and before retrieving the samples. This protocol allows the top steel plate to slightly cool and reduces the attraction between the plate and the top release liner. Taken together, it was possible to reach an MLR range of 0.05 to 0.5 for the 11-120 kGy range without significant fragmentation of the sample.

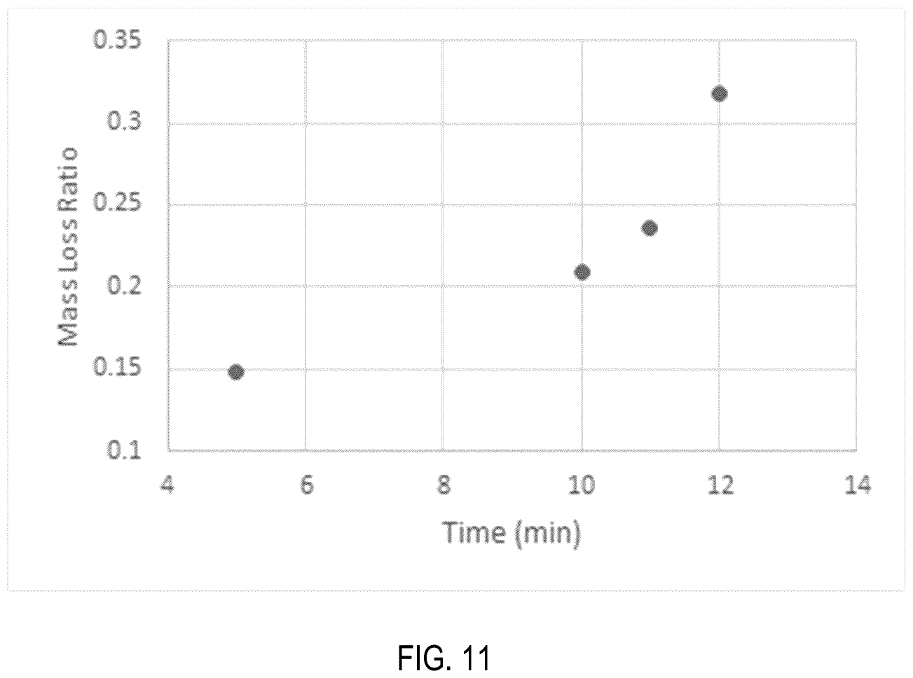

While the combination of hot press compression adequately covered the 11-120 kGy range (shown in FIG. 11), the resolution was inadequate for discerning dose effects via MLR for dose levels in the 0-11 kGy range. In FIG. 11, MLR is shown for 124 kGy resins held at 193° C. (380° F.) for various time durations under 6672 N (1500 lbF). Data was obtained with single samples at each hold time. Considering that the issues pertaining to sample disintegration are more pronounced for higher dose levels, a new optimal set of temperatures and hold times were examined for the 0 to 11 kGy range.

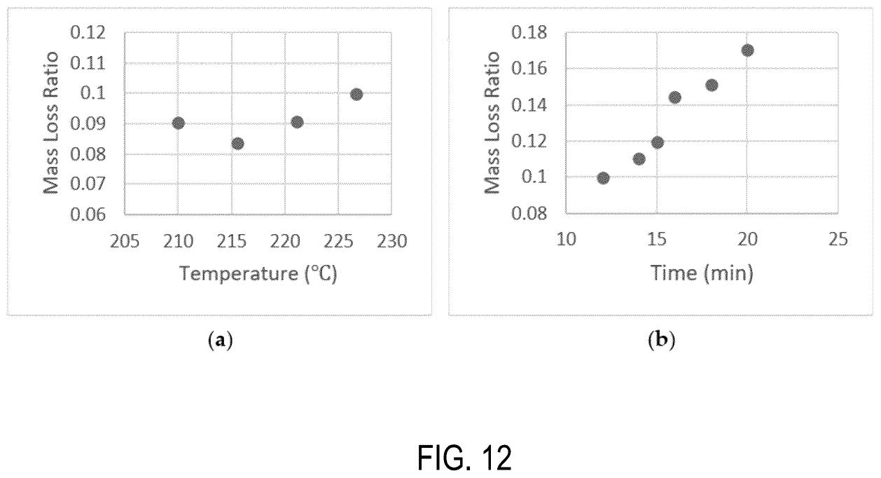

As a start, keeping the hold time at 12 min, the MLR was found for an irradiated 9.5 kGy gamma dosed PLA 4043D resin sample at various temperatures from 210° C. to 227° C. (close to the decomposition temperature), for which the results are shown in graph (a) of FIG. 12. Thereafter, the hold time was increased from 12 min through 20 min, and the corresponding results for holding under 6672 N (1500 lbF) at 227° C. (440° F.) are shown in graph (b) of FIG. 12, which indicates a sharp increase at ˜16 min. It was also found that for hold times above 16 min at 227° C. (which is above the recommended temperature of 218° C. for the release liner), the liner started to burn and cause adhesion-related disintegration of the PLA.

Consequently, for the 0-11 kGy range, the optimal test parameters were set at 227° C. and 16 min hold time. This combination allowed the MLR values to range from 0.05 at 0 kGy to about 0.2 at 11 kGy.

MLR-related testing was conducted for the test parameters summarized in Table 3.

TABLE 3
Testing matrix (Loading Force: 6672N (1500 lbf)).

| Doses Tested (kGy) | | | |
|---|---|---|---|
| (Resins Irradiated | Temperature | | |
| in 2021) | (° F./° C.) | Hold Time (min) | Rest Time (min) |
| 0, 1.0, 2.1, 2.8, 4.5, | 440/227 | 16 | 1 |
| 7.0, 8.7, 11.2 | | | |
| 0, 11.4, 21.0, 33.4, | 380/193 | 12 | 1 |
| 43.8, 66.7, 85.8, | | | |
| 114.4 | | | |

### Experimental Procedure

PLA resin beads were irradiated to varying levels from 0 to 114.4 kGy using Purdue's GammaCell™ irradiator. Taking into account Co-60 decay over time, the gamma doses were evaluated by multiplying the time-averaged dose rate over the irradiation duration by the irradiation time, then converted to the actual dose absorbed by PLA using the method described above. These irradiated resin beads were then used to prepare coupon samples for placement in the Carver™ Hot Press for set durations of time, depending on the dose range being considered.

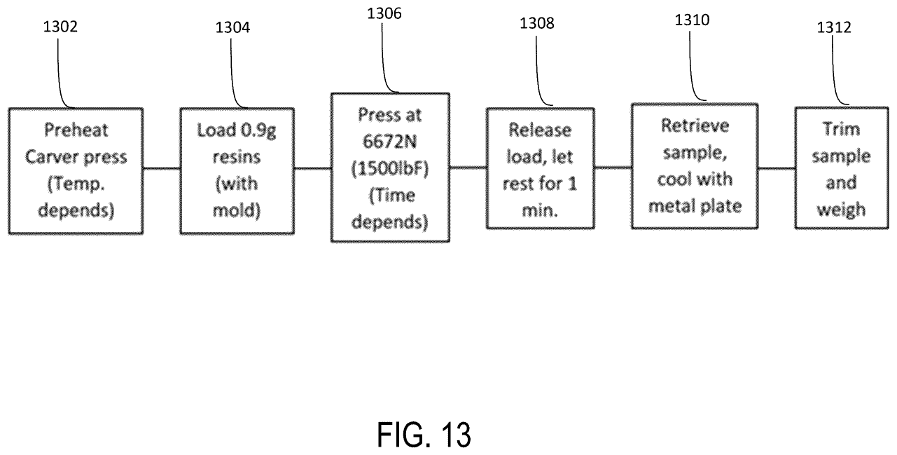

FIG. 13 illustrates in a flowchart the steps taken for testing the irradiated PLA resin in the Carver™ Hot Press. The press was first preheated to the desired temperatures and allowed to stabilize together with the two steel plates used to separate the platens and the sample; then, the PTFE frame was placed between the two steel plates at the centerline of the press. PLA resin beads were weighed and loaded into the PTFE frame. A release liner (parchment paper) covered the top and bottom surfaces, as discussed earlier. It takes ˜30 s for the press to reach 6672 N (1500 lbf) after the platens have been closed, before it was held in place for hold and rest times specified in Table 3, respectively. After the platens were raised, the sample was retrieved together with the mold and release liner. The sample was placed on a flat surface, with a metal plate loaded on top until it cooled down. After removing the sample from the mold, the PLA material released out of the central cavity was trimmed, followed by mass measurements. The difference between the original and remaining mass in the mold cavity is the mass loss (ML) and MLR is evaluated per Equation (1). Several samples were prepared for each irradiation dose.

FIG. 13 illustrates the protocol for MLR determination. The first step 1302 including preheating the press to the desired temperature. The next step 1304 includes loading 0.9 g resins with the mold. At step 1306, the press reaches 6672N (1500 lbf). At step 1308, the load is released and there is a rest time of 1 minute. At step 1310, the sample is retrieved and cooled with the metal plate. At step 1312, the sample is trimmed and weighed.

In addition to the MLR, an accompanying metric based on sample porosity was also deemed intriguing for studying irradiation dose-induced changes to the PLA morphology.

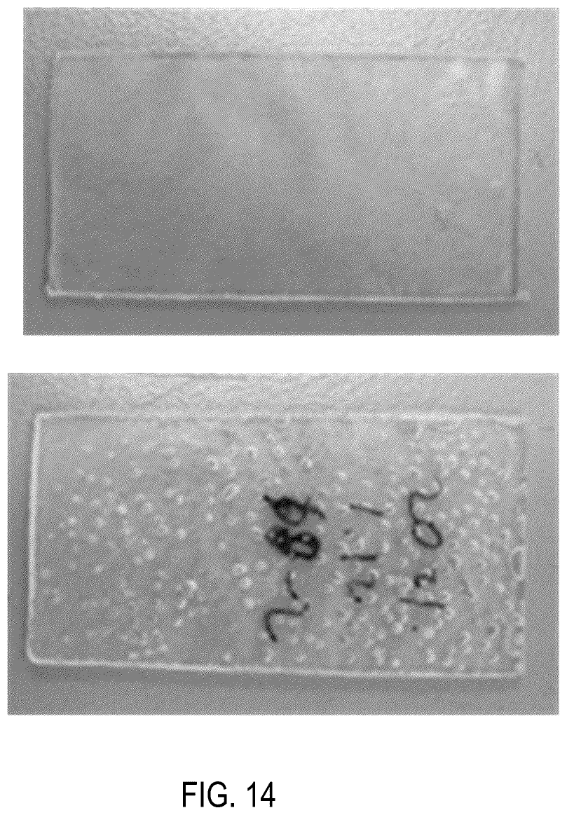

Interestingly, on a visual basis alone, the post-irradiated PLA resin beads from the GammaCell™ irradiator did not show any signs of void formation, even when viewed under an optical microscope. However, during the aforementioned MLR studies, it was found that gamma irradiation samples, when heated under compression, also gave rise to noticeable and significant voiding (porosity) of the PLA material. The degree of voiding fragmentation increased with irradiation dose. FIG. 14 shows the results of the samples for 0 kGy and 56 kGy (adapted to PLA) after subjecting the sample to the Carver™ Hot Press conditions mentioned earlier. The control (0 kGy) is shown at left, and has no visible pores. The 56 kGy gamma dose pre-irradiated sample is shown at right, and has visible pores.

The underlying physical cause of such macroscopic porosity change, which manifests itself only when subject to heat and compression, was not determined. A systematic effort was undertaken to derive an associated porosity metric for the absorbed dose.

The density change of PLA 4043D resins that underwent various doses of gamma irradiation was first examined by placing 5 g of resin beads of each selected dose in a 50 mL graduate cylinder containing 20 mL of distilled water and dividing the mass of the resin beads (5 g) by the volume change of the water. See Table 4 for a summary.

TABLE 4
Density of PLA 4043D resins irradiated
with 0, 66.7 and 114.4 kGy gamma doses.

| Gamma Dose (kGy) | Mass (g) | Volume (mL) | Density (g/mL) |
|---|---|---|---|
| 0 | 5.0 | 4.2 | 1.19 |
| 66.7 | 5.0 | 4.0 | 1.25 |
| 114.4 | 5.0 | 4.2 | 1.19 |

These results are within measurement uncertainty (for this relatively crude method) when compared with the published nominal density of PLA 4043D (1.24 g/cc) from Nature Works, LLC. It was concluded that irradiation alone through ˜110 kGy does not change the bulk density in any significant sense.

Without closer post-irradiation examination (PIE), and without wishing to be bound by any theory of operation, it is speculated that: (a) radiation induced chain-scission degradation of the macro-molecules reduces the original strength of the PLA molecular chains linked to the smaller molecules trapped between the chains. The source of the smaller molecules could likely be remnant solvent molecules, additives and water contamination during resin bead manufacturing. These additives (smaller molecules) make it easier for them to evaporate upon heating and lead to porosity; (b) radiolysis-related microbubbles and/or cracks (not visible under an optical microscope) are formed during irradiation; these fault lines then become nuclei for growing bubbles of vapor (water or other additives), which then expand and disrupt the structure when subjected to elevated temperatures.

In a practical sense, irradiation followed by compression under heat leads to visible and quantifiable porosity, thereby leading to an alternate Dg metric. However, clearly visible to the naked eye, porosity as a metric is not readily quantifiable due to the very significant size distribution of the pores, with sizes ranging from above 10 to 100 microns in effective radius. In order to develop a simple methodology and metric, it was decided to cast irradiated PLA resin beads into thin wafer samples such that the pore size was larger than the thickness of the wafer—this led to the need to press down the irradiated PLA resin beads to a thickness of ≤100 microns.

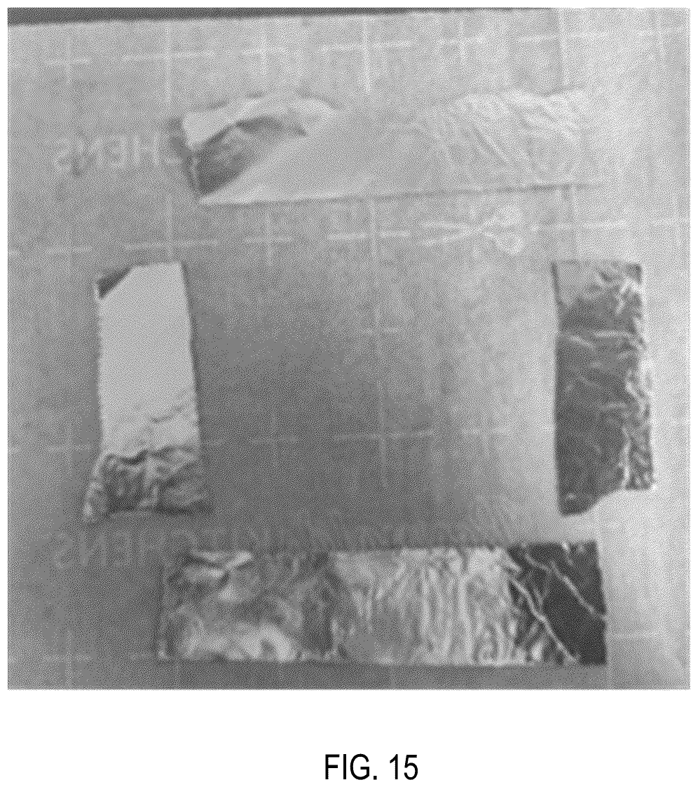

At first, the same combination of hot press conditions (i.e., force, temperature and hold time) were assessed as done for deriving the Dg metric using the MLR approach—with the only exception being the mold. Similar setups as for MLR were adopted for producing 100 μm thick PLA samples for the sake of consistency, except that the mold was replaced with surrounding 100 μm aluminum spacer strips, and the samples were replaced with one PLA bead for each dose. Beads used for all measurements had a weight of ˜0.040±0.005 g each. The load was also kept at 6228 N (1400 lbf). The same temperature/time conditions (193° C./12 min) were first applied to determine the porosity of 114 kGy. Without the PTFE mold, almost all PLA was lost (adhered to the release liner) with only insignificant disintegrated remnants left on the parchment paper (see FIG. 15). In FIG. 15, one 114 kGy PLA resin bead is shown, compressed under 6228 N at 193° C. for 12 min. Remnant PLA resin (encircled) is almost invisible.

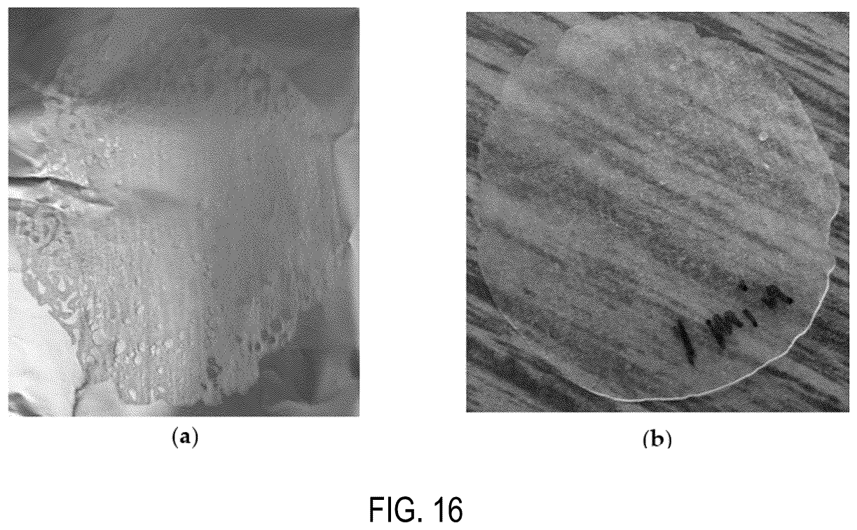

The porosity of the sample was affected by the hold time. By reducing the hold time down to 1 min, a more useful porosity-bearing sample could be derived. In this case, the PLA concentrated at the center while pores merged on the edge with irregular shapes, as seen in image (a) of FIG. 16. For doses below 33 kGy, no visible pores could be noted, as seen in image (b) of FIG. 16. In particular, FIG. 16 shows PLA resin beads compressed under 6228 N at 193° C. for 1 min. In image (a), corresponding to 114 kGy, visible pores are present at the edge. In image (b), corresponding to 33 kGy, no visible pores are present

Thus, in order to derive a porosity-based Dg metric, a different combination of force-temperature-hold times is needed as compared to the MLR-based approach. Thus, the present disclosure further provides a system and method for determining dose based on porosity that is similar to the MLR-based methodology described above.

Following a similar set of steps as done for the MLR approach through trial-error, the following parameters shown in Table 5 were derived for performing experiments with irradiated PLA to derive a porosity-related Dg metric:

TABLE 5
Hot press test parameters for porosity approach.

| Dose Range | Temperature-° C. | | |
|---|---|---|---|
| (kGy) | (F.) | Hold Time (min) | Force-N (lbf) |
| 0-16 | 232 (450) | 5 | 6,228 (1400) |
| 16-115 | 216 (420) | 2 | 6,228 (1400) |

Temperature higher than 232° C. was not selected due to the fact that it is close to the decomposition temperature of PLA (250° C.), and also far exceeds the maximum working temperature of the parchment paper (218° C.)—in which, the thin wafers of larger dose samples (>16 kGy) started to adhere to the parchment paper and was not easy to be retrieved without damaging the samples. The same phenomenon appeared for 114+ kGy samples pressed under 216° C./2 min conditions, and was even worse, which was why temperatures higher than 216° C. could not be utilized for the high dose range samples. The dose level of 16 kGy effectively became the boundary of the two sets of conditions since pores could barely be found on those samples prepared with 216° C./2 min conditions, making it the onset of the high dose range and the end point of the low dose range. This was different from that found for the MLR approach.

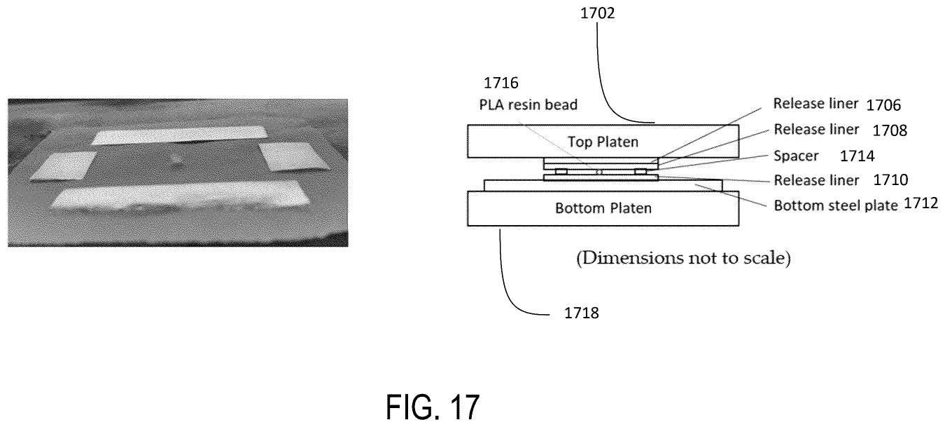

FIG. 17 (at left) shows placement of the PLA bead surrounded by the spacer strips. At right, a schematic of the hot press and various components for porosity measurements are shown, not to scale.

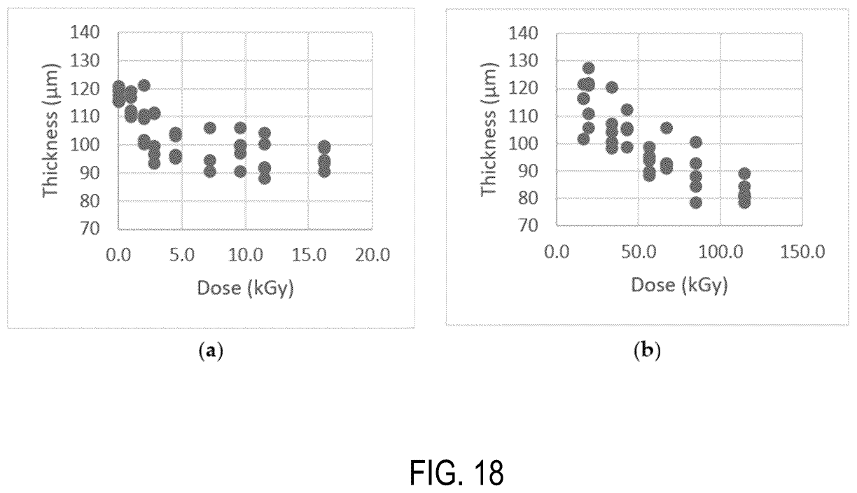

The spacers were made with 4 layers of Kroger® Heavy Duty Aluminum Foil, for which the total thickness was measured to be 104.0±0.5 μm. For convenience, when preparing the porosity-related wafer samples in the hot press, the top steel plate was not used; since the hold time was shorter (2 or 5 min) compared with that for the MLR approach, every time during the sample loading/unloading process, the temperature of the top steel plate dropped noticeably. An additional release liner was placed above the top release liner instead to avoid direct contact between the top release liner and the top platen of the press, as shown schematically (right) in FIG. 17. The thicknesses of the as-derived hot-pressed PLA samples versus the dose are shown in FIG. 18.

FIG. 17 (right) illustrates a schematic sketch of key components between platens. The top platen 1702 is above a first release liner 1706 and a second release liner 1708 which is placed between the top platen 502 and the spacer 1714. The spacer 1714 is between the release liner 1708 and a release liner 1710. A bottom steel plate 1712 is between a third release liner 1710 and the bottom platen 1718. In FIG. 18, graph (a) shows the thickness of the samples for porosity measurements at a dose range of 0-16 kGy, and graph (b) shows the thickness of the samples for porosity measurements at a dose range of 16-114 kGy.

Interestingly, the thickness of the 0-16 kGy samples (pressed under 232° C./5 min conditions) stabilized at a mean value of ˜100 μm, while the thickness of the 16-114 kGy samples (pressed under 216° C./2 min conditions) continued to reduce with increasing dose-even below that of the Al-strip spacers. Despite the +/−10 micron variation in the thickness of the wafers at each dose level, it appears that with further effort, controlled thickness change monitoring itself may also be possible as another simple and straightforward gamma dose metric for the future. Nevertheless, the as-produced wafer samples allowed the examination of pore distributions and sizes with a conventional optical microscope.

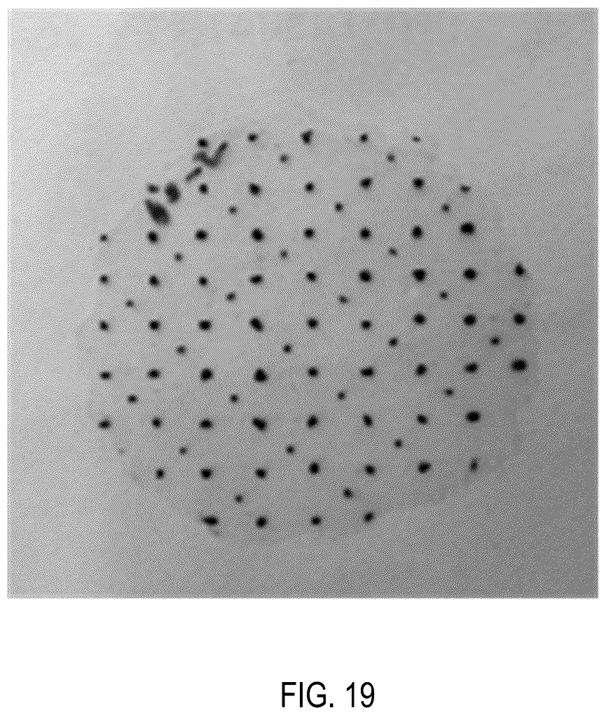

A DCM800™ Microscope was then used for porosity determination. Images were captured through the eyepiece of the microscope using an external digital camera. To determine the porosity consistently, ˜1 mm×1 mm grids were marked on each wafer sample—just enough to be included in the view of the minimum magnification of the microscope (40×). The integral pore areas in every other grid were calculated using the public domain (ImageJ) image processing software. An example of a grid is shown in FIG. 19, for a wafer sample of 56 kGy with ˜1 mm×1 mm grids. The darkened (blue) dots are indicators marking the grid locations to be measured for porosity. Two samples were measured at each selected dose.

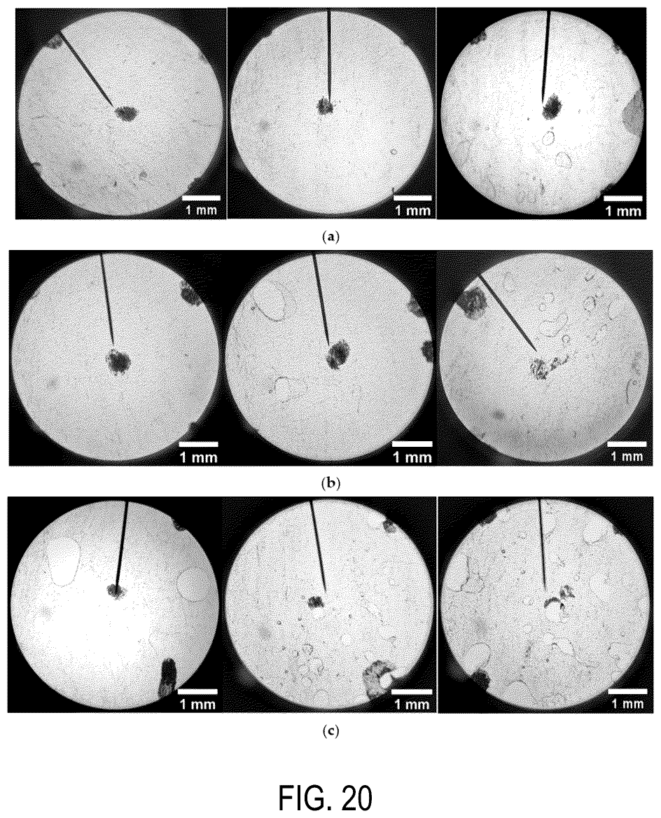

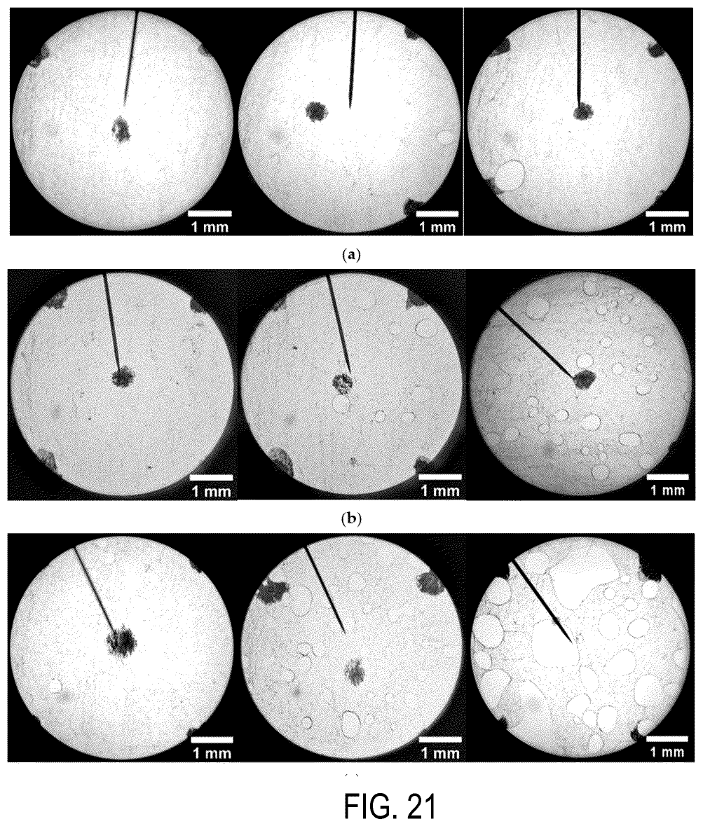

Due to time constraints, 3 irradiation dose levels were inspected for porosity for each dose range; two wafer samples were measured for at each selected dose. The microscope images were used to generate plots of area-averaged porosity as well as to gauge the relative sizes with increasing dose-typical images at three grid locations for 3 dose levels in each of the two dose ranges, as shown in FIGS. 20 and 21, respectively. In FIG. 20, microscope images at 40× magnification are shown for 0 kGy in the top row, 7.0 kGy in the center row, and 11.2 kGy in the bottom row. The hot press conditions for all images in FIG. 20 was 6228 N at 232° C. for 5 min. In FIG. 21, microscope images at 40× magnification are shown for 16.2 kGy in the top row, 56.2 kGy in the center row, and 114.4 kGy in the bottom row. The hot press conditions for all images in FIG. 20 was 6228 N at 216° C. for 2 min.

It can be observed that the pore distribution was not uniform for each individual sample. On the same sample, there could be areas where little or no pores are present, and areas where large portions of pores exist as well.

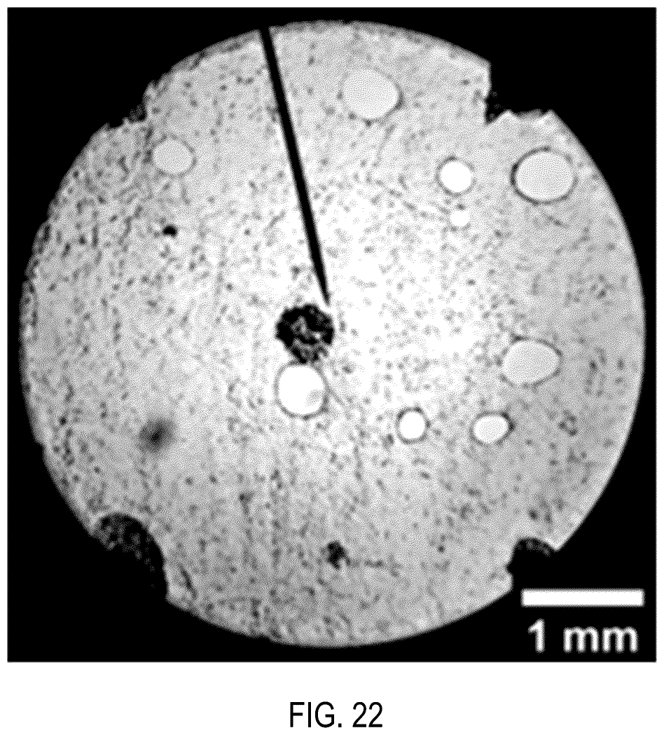

To count the pores more precisely, the images were processed and sharpened, as illustrated in FIG. 22 for a 56 kGy sample. The dimensions were scaled using an AmScope™ Microscope Stage Calibration Slide. To eliminate the uncertainty brought about by the external camera, the areas measured on each microscopic image were also normalized with the total area within the scope.

Porosity (P), or pore fraction, was determined by adding the total pore area of all pores taken on each sample and dividing the total area of all pictures within the scope of the microscope:

$$P = \frac{Total pore area within all grids selected}{Total area of all selected grids} \qquad ( 2 )$$

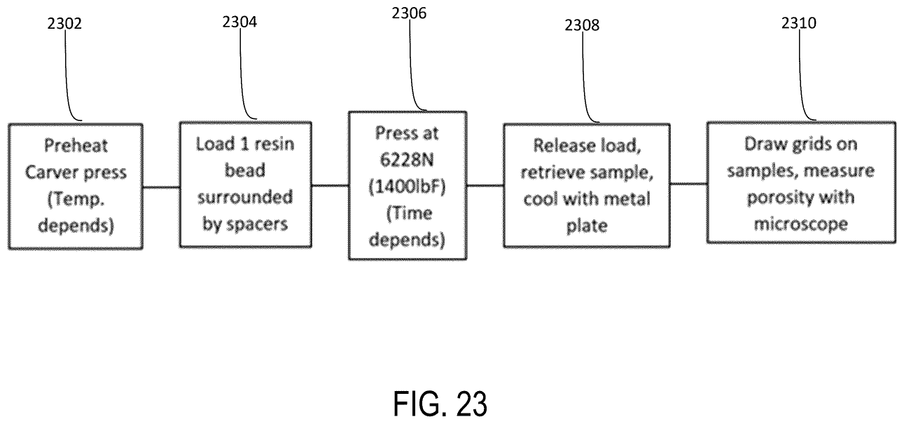

FIG. 23 illustrates the protocol for porosity-related wafer sample production and estimation. The first step 2302 including preheating the press to the desired temperature. The next step 2304 includes loading one resin bead surrounded by spacers. At step 2306, the press reaches 6228 N (1400 lbf). At step 2308, the load is released, the sample is retrieved and cooled with the metal plate. At step 2310, grids are drawn on the samples and porosity is measured with a microscope. Porosity-related testing was conducted for the test parameters summarized in Table 6.

TABLE 6
Experiment test matrix for porosity metric.

| Doses Tested (kGy) | Temperature (° F./° C.) | Hold Time (min) |
|---|---|---|
| 0, 7.1, 16.2 | 450/232 | 5 |
| 16.2, 56.2, 114.4 | 420/216 | 2 |

Hot Pressed Under 6228N (1400 lbf)

### Experimental Results

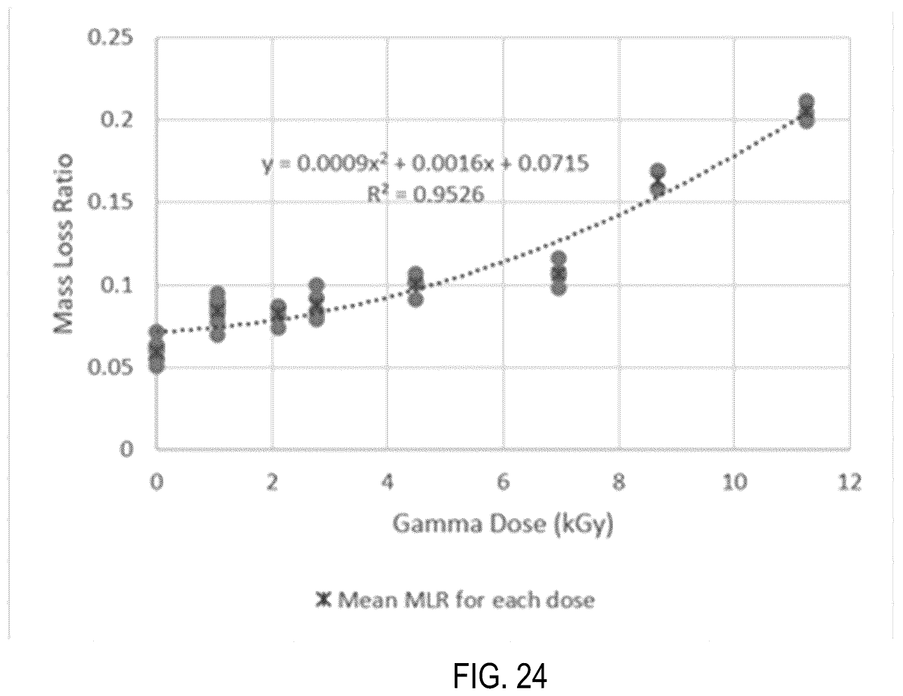

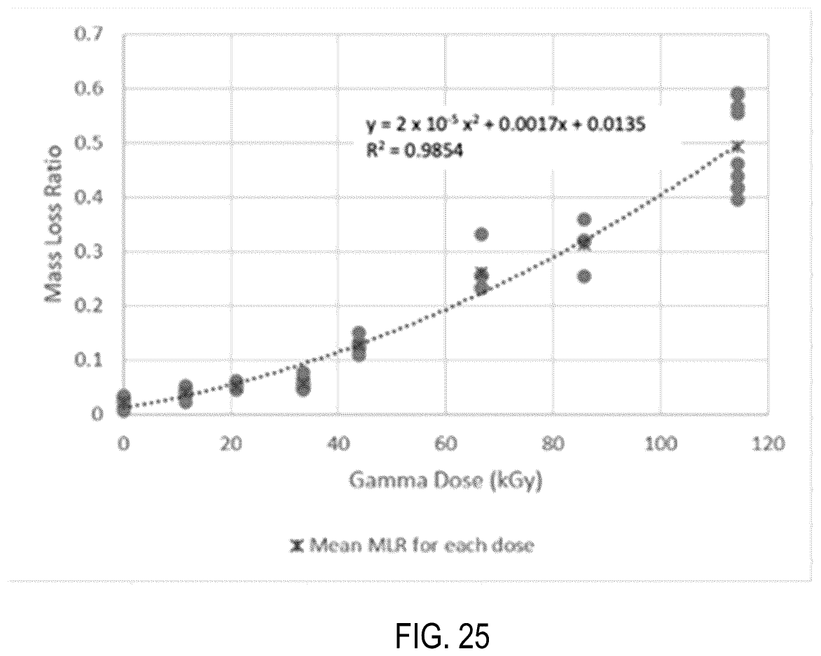

The MLR of hot pressed PLA resin for low dose range (0-11 kGy) and higher dose range (11-120 kGy) are shown in FIGS. 24 and 25. In particular, FIG. 24 shows the MLR of the PLA resin irradiated over 0-11 kGy gamma dose under hot press conditions of 227° C. with a 16 min hold time, and FIG. 25 shows the MLR of the PLA resin irradiated over 11-120 kGy gamma dose under hot press conditions of 193° C. with a 12 min hold time. The statistical analysis of the results is shown in Tables 7 and 8, respectively. Correlations using the least-squares approach for estimating MLR over the two specific Dg ranges examined were developed and are presented below:

$$M L R = 0.0 \; 009 {Dg}^{2} + 0.0 \; 016 Dg + 0.0 \; 715 {R}^{2} = 0.9526 ; 0 < D g < 11 kGy \qquad ( 3 )$$

$$MLR = 2 \times 1 {0}^{- 5} D {g}^{2} + 0.0017 D g + 0.0135 {R}^{2} = 0.9854 ; 0 < D g < 120 k G y ) \qquad ( 4 )$$

TABLE 7
Statistical analysis of the MLR of the PLA resins
irradiated with a 0-11 kGy gamma dose.

| Dose (kGy) | Mean | 1 σ | Median | Max. | Min. |
|---|---|---|---|---|---|
| 0 | 0.0596 | 0.0064 | 0.0600 | 0.0708 | 0.0502 |
| 1.0 | 0.0843 | 0.0079 | 0.0857 | 0.1016 | 0.0914 |
| 2.1 | 0.0820 | 0.0057 | 0.0836 | 0.0867 | 0.0741 |
| 2.8 | 0.0872 | 0.0087 | 0.0841 | 0.0998 | 0.0788 |
| 4.5 | 0.1002 | 0.0054 | 0.1012 | 0.1060 | 0.0914 |
| 7.0 | 0.1065 | 0.0072 | 0.1064 | 0.1155 | 0.0979 |
| 8.7 | 0.1635 | 0.0083 | 0.1635 | 0.1694 | 0.1577 |
| 11.2 | 0.2052 | 0.0061 | 0.2047 | 0.2115 | 0.1995 |

TABLE 8
Statistical analysis of the MLR of the PLA resins
irradiated with an 11-120 kGy gamma dose.

| Dose (kGy) | Mean | 1 σ | Median | Max. | Min. |
|---|---|---|---|---|---|
| 0 | 0.0240 | 0.0093 | 0.0266 | 0.0348 | 0.0082 |
| 11.4 | 0.0407 | 0.0097 | 0.0420 | 0.0541 | 0.0240 |
| 21.0 | 0.0537 | 0.0064 | 0.0534 | 0.0618 | 0.0463 |
| 33.4 | 0.0586 | 0.0113 | 0.0562 | 0.0775 | 0.0475 |
| 43.8 | 0.1278 | 0.0154 | 0.1250 | 0.1514 | 0.1097 |
| 66.7 | 0.2618 | 0.0405 | 0.2539 | 0.3316 | 0.2328 |
| 85.8 | 0.3134 | 0.0432 | 0.3202 | 0.3587 | 0.2547 |
| 114.4 | 0.4922 | 0.0813 | 0.4610 | 0.5908 | 0.3954 |

To depict the mass loss model, the relationship between MLR and the applied gamma dose was determined by fitting the response curve. On this basis, the volumetric thermal expansion theory was adapted as:

$$Δ V = {V}_{O} β ( {T}_{1} - {T}_{O} ) \qquad ( 5 )$$

where, ΔV is the volume change of an object when the temperature rises from T₀ to T₁, V₀ is the volume at T₀, β is the volumetric coefficient of expansion, and β=3α for a rectangular body, where a is the linear coefficient of thermal expansion for the material.

Coefficient of thermal expansion (CTE) a is therefore calculated for each sample with the following relationships:

$$Δ V = {m}_{r} / ρ \qquad ( 6 )$$

$${V}_{o} = {m}_{0} / ρ \qquad ( 7 )$$

where, mₒ is the original mass, mᵣ is the lost mass, ρ is the density and Vₒ is the volume of PLA, respectively. The rheology treatment of molten PLA leaking from the mold under certain temperature/time conditions is simplified to a thermal expansion model of a solid PLA chip and treat the mass lost (mᵣ) as the extruded mass from the mold assuming constant density. A “pseudo coefficient of thermal expansion” αₚₛ is derived in relation to the mathematical model for MLR:

$$M L R = \frac{{m}_{r}}{{m}_{0}} = \frac{Δ V * ρ}{{m}_{0}} = \frac{3 {V}_{0} {α}_{p s} ( {T}_{1} - {T}_{O} ) * ρ}{{m}_{0}} = A * ( {T}_{1} - {T}_{0} ) \qquad ( 8 )$$

where, A=3V0 αₚₛ ρ/mₒ=3αₚₛ is a constant, indicating MLR is linearly related to the temperature change. Combining Equations (3) and (4), it can be found that for samples prepared at a certain temperature,

$$\begin{matrix}{α}_{p s} = \frac{( 0.0009 D {g}^{2} + 0.0016 D g + 0.0715 )}{3} & 0 < Dg < 11 k G y\end{matrix} \qquad ( 9 )$$

$$\begin{matrix}{α}_{p s} = \frac{( 2 \times 1 {0}^{- 5} D {g}^{2} + 0.0017 D g + 0.0135 )}{3} & 0 < Dg < 120 k G y\end{matrix} \qquad ( 10 )$$

As aforementioned, pores are generated inside molten PLA upon heating, which drove the excessive PLA melt to escape from the mold and caused mass loss. This “pseudo CTE” measures the amount of molten PLA excluded from the mold upon heating in a confined volume, which in reality is a coefficient correlated to porosity. In other words, the more pores are generated, the larger the “pseudo CTE,” the more material is lost. Given the fact that irradiation causes little change in the density of PLA resin, there should be a linear relationship between porosity and mass loss.

This assumption agrees well with the experimental results, wherein a quadratic relationship is found in both curves (discussed in the next subsection). In theory, if porosity is accurately measured, the following equation would hold:

$$( {V}_{0} * P ) * p = {m}_{r} \qquad ( 11 )$$

where, V₀ is the volume of the mold cavity (assuming no distortion), P is the porosity, ρ is the density of PLA, and, mr is the mass removed (i.e., loss). Considering V₀*ρ=m₀ and MLR=mᵣ/m₀, Equation (11) is reduced to,

$$P = M L R \qquad ( 12 )$$

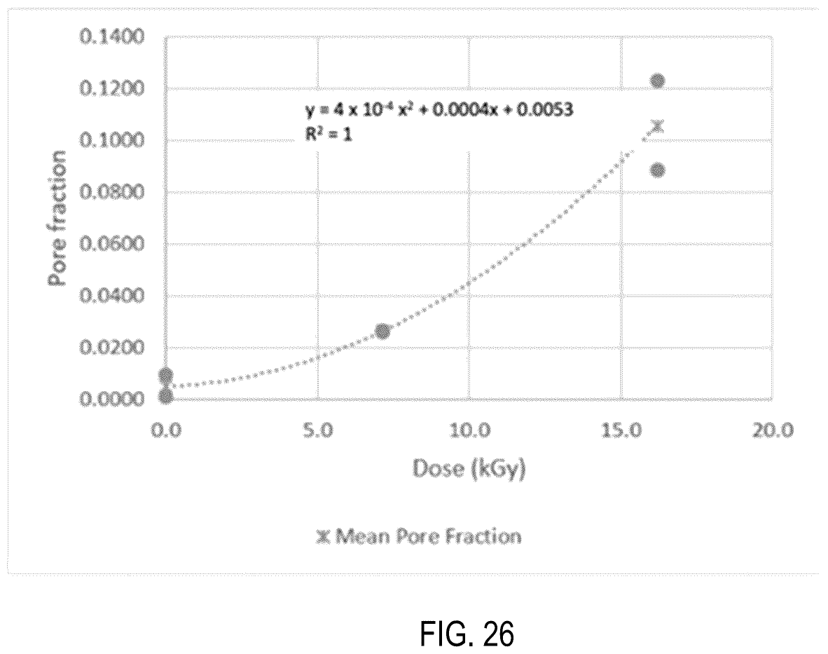

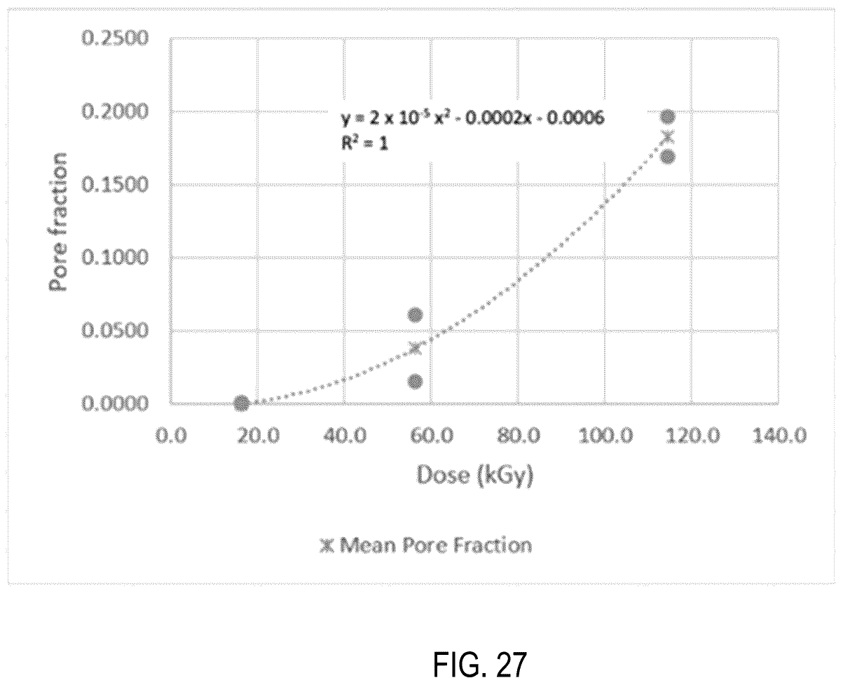

As stated above, two samples were measured for each dose. The average porosity of the two was calculated, and the results are shown graphically in FIGS. 26 and 27. In FIG. 26, the porosity is shown for the 0-16 kGy samples, and in FIG. 27, the porosity is shown for the 16-114 kGy samples. Correlations using the least-squares approach for estimating pore fraction (P) over the two specific Dg ranges examined were developed and are presented below:

$$\begin{matrix}P = 0. 0004 D {g}^{2} + 0.0004 D g + 0.0 \; 053 & {R}^{2} = 1 ; 0 < D g < 16 k G y\end{matrix} \qquad ( 13 )$$

$$\begin{matrix}P = 2 \times 1 {0}^{- 5} D {g}^{2} - 0.0002 D g - 0.0 \; 006 & {R}^{2} = 1 ; 16 < D g < 1 \; 14 kGy\end{matrix} \qquad ( 14 )$$

It is clear that the pore fractions increase as the dose increases quadratically in both dose ranges. The average pore fraction reached is ˜11% for the 0-16 kGy range, and ˜18% for the 16-114 kGy range, as noted from FIGS. 26 and 27, respectively. Notably, the pore fractions measured for two random samples for each dose were reasonably close to each other. Despite the limited number of tests and uncertainties, it may be said that porosity may be another viable metric for PLA dosimetry.

Looking back to the discussion above, unfortunately, the porosity-dose correlation cannot be directly related to the MLR-dose correlation, since the sample preparation protocols were different. Regardless, when comparing Equations (3) and (4) and Equations (13) and (14), it is noticed that the equations for the low dose range (<20 kGy) and the equations for the high dose range (20-120 kGy) for both methods have similar forms—the coefficients for the highest order in the low dose range equations are both in the 10⁻⁴ order while which in high dose range equations are both in the 10⁻⁵ order. This indicates an inherent correlation and inter-relationship between porosity and the mass loss ratio.

As a “green,” renewable corn-soy based polymer, PLA has promising potential to be developed into a cheap and efficient dose indicator, taking advantage of its degradation effect upon irradiation. In the present disclosure, two approaches to PLA dosimetry are presented. The first (MLR) approach is based on rheology, and the second (Porosity Fraction) is based on induced porosity levels post-irradiation.

MLR constitutes an approach reflecting the mobility of the melt leaking out from a half-sealed mold. The gamma response of PLA was investigated via MLR in this study. Different temperature/time combinations were adopted to check the MLR at different dose ranges. Neat response curves were found in both ranges.

As an extension study of the MLR metric, the porosity of PLA resins was developed into another metric for PLAD-based gamma dosimetry. A separate testing matrix was determined for porosity measurement, and similar to MLA, different conditions were applied to different dose ranges. These results were compared with those of MLR studies. While limited similarity was found, more needs to be done to better quantify the interrelationships between the two metrics. In this connection, as well, to improve upon and automate the processing of pore image scans for rapidly deriving the porosity metric.

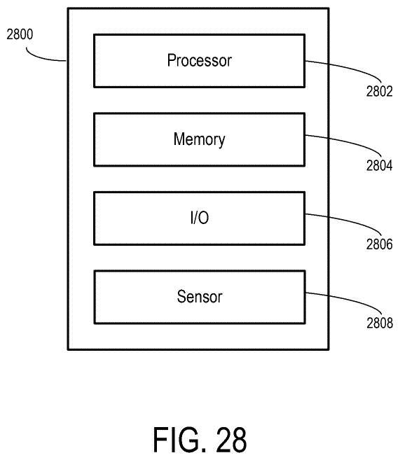

The above methodologies for PLAD-based dosimetry may be implemented with the use of a dose analysis device, one example of which is illustrated as the device 2800 of FIG. 28. The device 2800 may, in examples, be used with the radiation dose measuring systems illustrated in FIG. 5 and/or FIG. 17, and may be used in the methods for measuring radiation dose illustrated in FIG. 13 and/or FIG. 23.

The device 2800 includes at least one processor 2802, at least one memory 2804, an input/output (I/O) interface 2806, and a sensor 2808. The device 2800 may be configured with various modules (e.g., various software modules) to implement radiation dose analysis functions. In an example, the modules may be present in a non-transitory computer-readable medium (e.g., the memory 2804) in the form of instructions that, when executed by the processor 2802, cause the device 2800 to perform any one or more of the operations described herein. In another example, the processor 2802 may be configured to load and/or execute instructions from another non-transitory computer-readable medium (e.g., cloud storage or from the memory of another device).

The processor 2802 may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

The memory 2804 may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

The I/O interface 2806 may include interface components to permit the communication of data to and from external devices or sources. For example, the I/O interface 1906 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O interface 2806 may additionally or alternatively include communication ports and/or interfaces to permit communication with a user. For example, the I/O interface 2806 may include interfaces for a mouse, a keyboard, a display, a graphical user interface (GUI), buttons, switches, etc.

The sensor 2808 may include one or more individual sensing devices that are respectively configured to sense (e.g., measure, determine, calculate, etc.) a physical parameter of a sample (e.g., as described above with regard to FIGS. 5 and/or 17) after it has been compressed in a hot press (e.g., as described above with regard to FIGS. 13 and/or 23). The sensor 2808 may be or include, for example, a scale or other mass-determining sensing device. Additionally or alternatively, the sensor 2808 may be or include, for example, a microscope or other optical inspection device. While FIG. 28 illustrates the sensor 2808 as being included within the device 2800, in some implementations the sensor 2808 may be external to the device 2800 and configured to communicate with the device 2800 (e.g., via the I/O 2806). In either configuration, the sensor 2508 may be configured to communicate data indicative of the physical parameter of the sample to the processor 2802 and/or the memory 2804. The processor 2802 may then be configured to output the radiation dose based on the data indicative of the physical parameter (e.g., after retrieving the data from the memory 2804 if necessary). The radiation dose may be output to the memory 2804, to a display associated with the I/O interface 2806, to an external device, or combinations thereof.

The PLAD technology discussed in the present disclosure utilized semi-crystalline form PLA, for which the crystalline nature of the polymer with irradiation could well be affected during the cooling phase post-compression at elevated temperatures. As such, morphological changes pertaining to crystallinity may also be useful for further characterizing gamma dosimetry, e.g., via wide angle x-ray diffraction (WAXD) techniques.

As mentioned earlier, gamma radiation detection is an example of a field in which the methodologies discussed herein may be applied. PLAD may also be of utility for space-based applications where, at present, various detector types such as InGaAsP/InP resonators, and Si-on-Si and Si-on-insulator microphotonic devices are being researched together with PLA. Studies examined gamma irradiated 3-D printed PLA samples for morphological changes using well-established laboratory techniques such as FTIR, DSC and structural-impact strength related properties (tensile/bending, elongation, modulus of rupture, hardness, etc.) of specimens. The techniques used for this analysis showed little to no significant changes for Co-60 gamma doses below 50 kGy. Overall, the PLAD's MLR approach represents an effective and simple approach for enabling PLA resin to be used for medical gamma dosimetry for the interesting (biomedical field relevant) dose range spanning 1-100 kGy. Above, only the y response of PLAD has been studied; it is expected that this approach can be applied to other types of ionizing irradiation as well, i.e., electron, neutron and alpha irradiation.

Acronyms used herein include: PLA: Polylactic acid; Dg: Gamma dose; ML: Mass loss; MLR: Mass loss ratio.

Although the invention has been described and illustrated in the foregoing illustrative aspects, it is understood that the present disclosure has been made only by way of example, and that numerous changes in the details of implementation of the invention can be made without departing from the spirit and scope of the invention, which is limited only by any allowed claims that are entitled to priority to the subject matter disclosed herein. Features of the disclosed aspects can be combined and rearranged in various ways.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such aspects or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its aspects.

What is claimed is:

1. A system for measuring a radiation dose, comprising:
a first platen;
a second platen disposed opposite the first platen; and
a sample assembly disposed between the first platen and the second platen, the sample assembly comprising a first release liner, a second release liner, a mold disposed between the first release liner and the second release liner, and a sample disposed between the first release liner and the second release liner and adjacent to the mold, wherein the sample has been exposed to the radiation dose and includes a polylactic acid (PLA) resin,
wherein the first platen and the second platen are configured to compress the sample assembly in a heated state.

2. The system of claim 1, further comprising a measurement device configured to measure a physical parameter of the sample and output the radiation dose based on the measurement of the physical parameter.

3. The system of claim 2, wherein the physical parameter is a mass loss ratio of the sample.

4. The system of claim 3, wherein the compression force is about 1500 lbf.

5. The system of claim 3, wherein the mold includes a frame formed of a low surface energy (LSE) material, the frame having an inner cavity to receive the sample.

6. The system of claim 2, wherein the physical parameter is a porosity of the sample.

7. The system of claim 6, wherein the compression force is about 1400 lbf.

8. The system of claim 6, wherein the mold includes at least two spacers disposed so as to surround the sample.

9. The system of claim 1, wherein the first platen and the second platen are configured to compress the assembly at a predetermined temperature and a predetermined duration.

10. The system of claim 9, wherein at least one of the predetermined temperature or the predetermined duration is selected based on an expected range of the radiation dose.

11. A method for measuring a radiation dose, the method comprising:
preheating a hot press, wherein the hot press includes a first platen and a second platen;
receiving a sample assembly within the hot press, wherein the sample assembly includes a first release liner, a second release liner, a mold disposed between the first release liner and the second release liner, and a sample disposed between the first release liner and the second release liner and adjacent to the mold, wherein the sample has been exposed to the radiation dose and includes a polylactic acid (PLA) resin;
compressing the sample assembly with the hot press;
measuring a physical parameter of the sample; and
outputting the radiation dose based on the measurement of the physical parameter.

12. The method of claim 11, wherein the physical parameter is a mass loss ratio of the sample.

13. The method of claim 12, wherein measuring the physical parameter includes trimming the sample after compressing, and weighing the sample after trimming.

14. The method of claim 12, wherein the compression force is about 1500 lbf.

15. The method of claim 12, wherein the mold includes a frame formed of a low surface energy (LSE) material, the frame having an inner cavity to receive the sample.

16. The method of claim 11, wherein the physical parameter is a porosity of the sample.

17. The method of claim 16, wherein measuring the physical parameter includes drawing grids on the sample, and measuring the porosity using a microscope.

18. The method of claim 16, wherein the compression force is about 1400 lbf.

19. The method of claim 16, wherein the mold includes at least two spacers disposed so as to surround the sample.

20. The method of claim 11, wherein at least one of a temperature of the hot press or a duration of the compressing is selected based on an expected range of the radiation dose.
